(19) United States
(12) Patent Application Publication
(10) Pub. No.: US 2010/0285224 A1
(43) Pub. Date: Nov. 11, 2010

(54) Agent and method for curing pervious concrete

(76) Inventor: Dale Fisher, Woodstock, GA (US)

Correspondence Address: Andrew K. Youngs, 4904 Falconwood Way, Antelope, CA, 95843, US

(21) Appl. No.: 12/387,902

(22) Filed: May 11, 2009

(51) Int. Cl. C08K 3/34; C08K 5/06; C08G 63/00; C04B 24/24; B05D 3/10

(52) U.S. Cl. 427/343; 524/377; 524/443; 524/599; 524/2

(57) ABSTRACT

The use of pervious concrete has been rapidly growing as a means to meet burgeoning stormwater regulations. A difficulty in placement of pervious concrete has been the need to rapidly cover the material after placement and leave it covered for seven days to ensure moisture is not lost and the cement paste fully cures. Surface unraveling is a common cause of failure of pervious concrete installations due to rapid moisture loss from the cement paste of the freshly placed pervious concrete mixture.

By adding to the pervious concrete mixture an internal curing agent which holds and releases moisture in a controlled manner to the cement paste as it cures, the likelihood of under-cured cement paste and surface raveling of the pervious concrete is greatly reduced. This invention comprises materials and methods for their use which provide a source of moisture with controlled release for curing of the cement portion of pervious concrete.

A further feature of this invention is the use of a partial sodium salt of a cross-linked polypromancic acid (CAS 009033-79-8) along with ground-granulated blast furnace slag, amorphous silica and crystalline silica to provide a superabsorbent material which readily disperses in cement paste, absorbs water from the cement paste and then releases it slowly over time, with the superabsorbent material remaining inert and non-absorbent once all the moisture is released.

Utilization in conventional concrete either as an internal or as a topical cure is a further feature of this invention.

### RELATED U.S. APPLICATION DATA

This application claims priority to Fisher U.S. provisional application 61/126,455 filed May 5, 2008, the contents of which are incorporated into this specification by reference.

### BRIEF DESCRIPTION OF THE FIGURES

FIG. 1 is a table of an exemplary HydroMax concrete curing composition.

FIG. 2 is a diagram showing the typical process flow of placing pervious concrete.

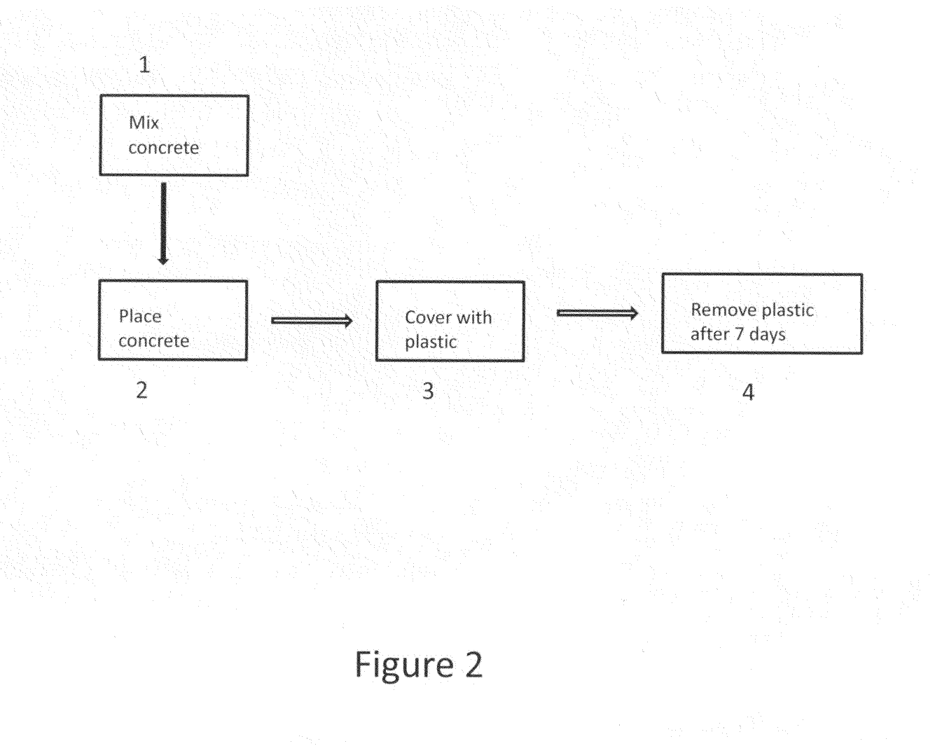

FIG. 3 is a diagram which shows the typical process flow of placing pervious concrete which contains HydroMax curing agent.

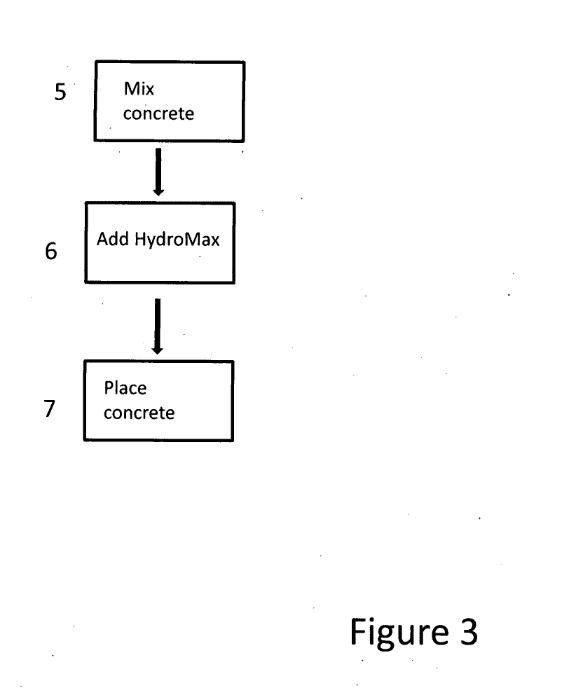

### BACKGROUND OF THE INVENTION

Pervious concrete has been utilized in the United States for over 30 years. This material comprises portland cement, coarse aggregate, water, and additives, in proportions to provide a strong, stable, durable mass which allows water and air to flow freely through it. Pervious concrete is also referred to as porous concrete, permeable concrete, no-fines concrete, enhanced porosity concrete, popcorn, draincrete, and a variety of other names.

Pervious concrete technology is described in detail in Portland Cement Association Publication EB-302, Pervious Concrete Pavements, by Tenis, Leming and Akers, which is incorporated by reference into this document.

This mixture of gravel, cement, water and additives which comprises pervious concrete can be made from a wide variety of aggregate types, with the gradation of the aggregate dependant upon desired aesthetics, surface smoothness and water infiltration rates. Numerous additives are utilized in pervious concrete mixtures, including supplementary cementitious materials such as fly ash, silica fume or ground granulated blast furnace slag (slag), and chemical admixtures such as surfactants, water-reducing admixtures, air-entraining admixtures, latex additives, acrylate polymers and many others. The curing admixture described and claimed in this invention may be utilized in conjunction with any of these myriad of additives, or combinations thereof.

Pervious concrete has been well-described in the patent literature, with patents as far back as 1943 (Patch, U.S. Pat. No. 2,315,732) and 1952 (Mangold, et.al., U.S. Pat. No. 2,793,957) describing methods and compositions for producing permeable concrete mixtures. In 1980 Hodson in U.S. Pat. No. 4,225,537 described and claimed a method for production and placement of pervious concrete which is essentially the technology utilized in common practice today for pervious concrete.

In common practice, the water content of a pervious concrete mixture is kept very low, with a water-to-cementitious ratio (W/C ratio) of 0.45 or below, with 0.27-0.30 W/C ratio being very common. This low W/C ratio maximizes the strength of the cement paste, and is an important part of attaining useable pavement strength and durability of pervious concrete.

Because of the open structure of the pervious concrete and the thin nature of the cement paste coating on each aggregate, evaporation of water from the cement paste during placement and subsequent curing is a common cause of poor pervious concrete placements. If too much moisture evaporates from the cement paste, the bond of the aggregates to each other is weakened, especially on the upper surface, and raveling, or release of the top aggregate pieces from the surface, commonly occurs.

In order to retain the moisture within the pervious concrete structure and ensure full strength development, a plastic sheet is generally affixed to the surface of the pervious concrete just after it is placed, screeded and compacted, to prevent evaporation of the water within the cement paste. When the plastic sheeting is properly placed and secured, what water does evaporate from the cement paste is retained within the pervious concrete structure as water vapor and droplets, providing a condensing humidity environment ideal for the curing of the cement paste of the pervious concrete.

U.S. Pat. No. 5,971,656 to Kitsmiller describes and claims an advanced method of pervious concrete placement. This patent and nearly all patents detailing pervious concrete placement techniques rely on the use of an impervious barrier such as a sheet of plastic to keep the moisture in the cement paste and provide the humid environment necessary for proper curing. It is the object of this invention to eliminate the need for such curing films, or provide for a means of enhancing cure even when such a film is utilized.

A number of patents exist for the composition and production of super-absorbent materials. As an example, US Re. 32,649 to Brandt, et. al. in 1988 describes and claims hydrogel-forming polymer compositions for use in absorbent structures. The hydrogels are generally utilized in single-use applications such as diapers, where their ability to absorb many times their weight in water-based liquids is valuable.

Most super-absorbent hydrogels commercially used have the capability to absorb moisture and store it, swelling in size as they do so, then release it in more arid conditions, and re-absorb additional moisture when it is available. Some hydrogels, such as a partial sodium salt of cross-linked polypromancic acid (CAS No. 009033-79-8), absorb several times their weight in water, release that water slowly in arid conditions, but remain inert after releasing the moisture, without capability of re-absorbing water and swelling again. One version of such a hydrogel is is trademarked Superabsorbent and is available from Aquitain, Inc.

Anderson, et. al., in U.S. Pat. No. 6,984,419 B2 (Jan. 10, 2006) describes and claims a hydrogel forming polymer suitable for agricultural use, wherein the hydrogel absorbs water and swells, slowly releasing it into the soil during arid conditions, reabsorbing water when it rains, to try to keep the moisture content of the soil suitable for plant growth even in very dry periods.

The use of water-absorbing materials in concrete structures is described in the patent literature. Ellenberger, et. al. in U.S. Pat. No. 5,925,699 (Jul. 20, 1999) describes and claims a concrete curing admixture consisting of a water-soluble polyalkylene oxide and a superabsorbent polymer. This invention is very narrowly defined by the use of polyalkylene oxides of a certain molecular weight range, and the specification details its use for layered constructions such as shotcrete placements, wherein the moisture retention benefits are limited to a relatively short time period, and are used to improve bonding strengths of shotcrete layers applied within hours of each other. The current invention releases its water over a period of several days, and is utilized to allow low W/C ratios to be utilized in arid conditions without fear of loss of cement paste strength due to evaporation and drying.

Compernass, et. al. in U.S. Pat. No. 3,847,630 (Nov. 12, 1974) describes and claims a similar application wherein a water-soluble compound such as starch, plant gums, etc. are utilized in a mixture of specific aggregate proportions to make a sprayable composition which is permeable and wherein the setting process of the cement is delayed so that multiple layers can be built up. The mixture in Compernass is designed specifically to reduce rebound in shotcrete applications and to provide multiple layer bonding. This bonding, as in Ellenberger, occurs over a period of hours rather than days.

Before the present invention is further described, it is to be understood that this invention is not limited to particular embodiments described, as such embodiments may, of course, vary. It is also to be understood that the terminology used herein is for the purpose of describing particular embodiments only, and is not intended to be limiting, since the scope of the present invention will be limited only by the appended claims.

Where a ranges of values are provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

Where specific amounts of materials to be utilized is not specified, the amounts used shall be considered to be those within or within plus or minus 50% of the ranges that one skilled in the art of concrete mix design would utilize for that class of material (such as cementitious materials, aggregates, admixtures, curing agents, etc.) in the concrete mix.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The current invention comprises concepts, apparatus and methods which can produce better results than the current art available. The use of the invention by itself or in conjunction with any particular set of complimentary materials or methods shall not be construed as a limitation.

### DESCRIPTION OF THE INVENTION

The invention of this application comprises the use of a mixture comprising a hydrogel as an internal curing agent for cementitious mixtures. The invention may also be made into a slurry and used as an externally applied curing agent or as an internal curing admixture. In addition to the hydrogel, additional additives such as slag, silica fume and chemical admixtures may be utilized to provide additional benefits.

Hydrogel-forming polymers are often polycarboxylates. A partial sodium salt of cross-linked polypromancic acid is commercially available (CAS No. 009033-79-8) from Aquitain, Inc. trade-named SuperAbsorbent, and can be used in the current invention as an effective superabsorbent material for providing internal moisture curing of concrete, particularly pervious concrete. Dosage rates as low as 0.05% by weight based on cement content and as high as 10% by weight based on cement content have proven to be effective.

Many absorbent materials absorb water, release it, and then can absorb water again. One of the advantages of polypromancic hydrogels is that once the absorbed water is released, the polymer is no longer capable of reabsorbing water. This prevents internal pressures in the concrete which could be caused by re-absorption and swelling of the polymer after the concrete is cured.

In addition to the polypromancic hydrogel, slag, silica fume and water can be utilized to form an easily utilized and dispersed fluid admixture for concrete. In one example, a powdered internal curing admixture for use in pervious concrete comprised:

| | |
|---|---|
| Polypromancic polymer (Aquitain SuperAbsorbent) | 8% by weight |
| Ground Granulated Blast Furnace Slag | 50% by weight |
| Silica Fume | 20% by weight |
| Water | 22% by weight |

The powdered ingredients were gradually added to the water under high shear mixing, and mixed for about 3 minutes until a uniform suspension was obtained. This curing mixture was added to the drum of a ready mix concrete truck after the concrete was in the truck, and mixed for about 100 revolutions at high speed to disperse the mixture into the concrete. When added to a pervious concrete mixture with a total cementitious content of 570 pounds per cubic yard, dosages of 10 pounds per cubic yard of said internal curing admixture produced a pervious concrete mixture which was placed with conventional techniques, not covered with plastic, yet produced a surface with no raveling or loose gravel, and a compressive strength equal to a control placed with plastic cover and no internal curing agent.

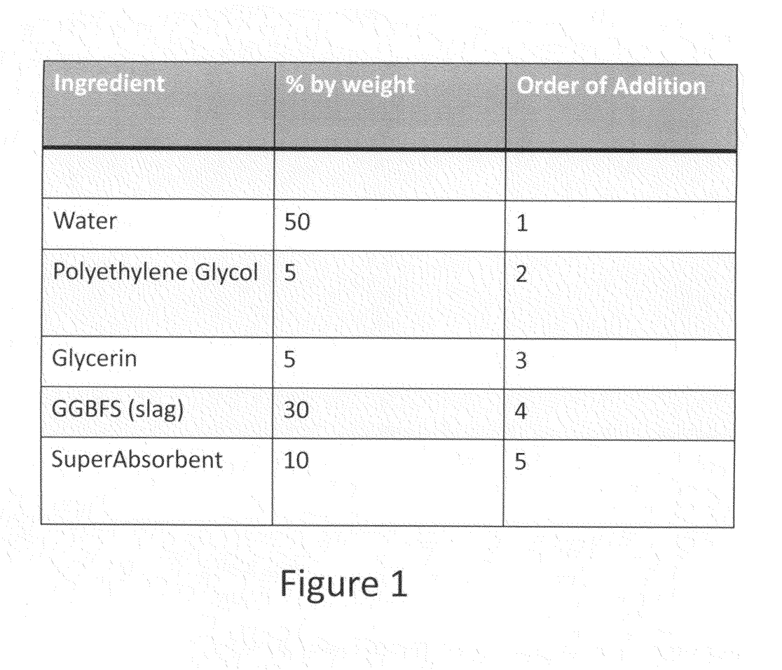

In an additional example, the curing agent was comprised of the formula detailed in FIG. 1. The ingredients were added in the order listed in FIG. 1 under high shear mixing, and were mixed for 3 minutes after all ingredients were added. The curing agent was added to pervious concrete at a dosage rate of one gallon per cubic yard, and the pervious concrete was placed in the conventional manner. Though there was as much as an hour gap in between trucks, the pervious concrete maintained a wet edge and the finished job had no poor cold joints, as would have been expected without the curing admixture.

In a further example, HydroMax powder consisting of a mixture of Superabsorbent, slag and silica fume was placed into a 9 cubic yard load of pervious concrete and the mix was placed in three parking stalls in a parking lot. A moister meter was inserted in the pervious concrete and monitored for the duration of the seven day curing period. Throughout the curing period the moister meter stayed above 30 %, indicating sufficient moisture was present to cure the pervious concrete. Additional parking stalls placed without HydroMax were covered with 6 mil poly sheeting (left on for 7 days) while the stalls with HydroMax were left un-covered. After the plastic sheeting was removed and the parking lot dried, the stalls that were placed with HydroMax were slightly darker in color. The color difference faded in time and within 30 days there was no noticeable difference in color.

The composition of the examples described are by no means restrictive—there are numerous combinations of materials and methods which can achieve desired results, and the examples as stated are not to be construed as restrictive of the invention.

I claim:

1) A curing agent for use in concrete comprising a superabsorbent material.

2) The curing agent of claim 1 where the superabsorbent material is a polymer.

3) The curing agent of claim 2 wherein the polymer is a hydro-gel forming polymer.

4) The curing agent of claim 3 wherein the hydro-gel forming polymer is a polypromancic polymer.

5) The curing agent of claim 1, wherein a dispersant is added to the curing agent.

6) The curing agent of claim 5, wherein the dispersant comprises glycerin, ground granulated blast furnace slag, or polyethylene glycol.

7) The curing agent of claim 6, wherein there are two or more dispersants used.

8) The curing agent of claim 1, wherein water is added to form a liquid curing agent.

9) The curing agent of claim 5, wherein water is added to form a liquid curing agent.

10) A curing agent for use in concrete comprising:
0.05% to 10% by weight of a hydro-gel forming polymer;
0.0% to 75% by weight slag;
0.0% to 75% by weight silica fume;
and
10% to 80% by weight water.

11) The curing agent of claim 10, wherein:
the hydrogel forming polymer consists of a partial sodium salt of cross-linked polypromancic acid.

12) The curing agent of claim 1, wherein:
the hydrogel does not reabsorb water once it releases the bound water in the hydrogel.

13) The curing agent of claim 10, wherein:
the hydrogel does not reabsorb water once it releases the bound water in the hydrogel.

14) A curing agent for use in concrete comprising:
0.05% to 10% by weight of a hydro-gel forming polymer;
0.0% to 75% by weight slag;
0.0% to 30% by weight glycerin;
0.0 to 30% by weight polyethylene glycol;
and
10% to 80% by weight water.

15) A concrete mixture comprising:
the curing agent of claim 1;
cementitious materials;
aggregate;
water;
and
admixtures.

16) A concrete mixture comprising:
the curing agent of claim 8;
cementitious materials;
aggregate;
water;
and
admixtures.

17) A concrete mixture comprising:
the curing agent of claim 12;
cementitious materials;
aggregate;
water;
and
admixtures.

18) A pervious concrete mixture comprising:
the curing agent of claim 1;
cementitious materials;
coarse aggregate;
water;
and
admixtures.

19) A means of curing concrete comprising:
placing the concrete;
then spraying the curing agent of claim 9 on the surface.

20) A means of curing concrete comprising:
adding the curing agent of claim 1 to the plastic concrete mix;
then placing the concrete.
